(19) United States
(12) Patent Application Publication
(10) Pub. No.: US 2003/0093015 A1
(43) Pub. Date: May 15, 2003

(54) Massaging shoulder exerciser

(76) Inventor: Yuan-Hung Lo, Taipei (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/010,488

(22) Filed: Nov. 13, 2001

(51) Int. Cl. A61H 7/00

(52) U.S. Cl. 601/84

(57) ABSTRACT

A massaging shoulder exerciser includes a resilient hoop, a handle formed in a portion of the resilient hoop, and a pad formed in another portion of the resilient hoop opposed to the handle. Multiple massaging protrusions are formed on an inner surface of the pad. When in operation, the resilient hoop is disposed around a user's shoulder and the massaging protrusions are attached to an aching portion of the shoulder desired to be massaged. The user grasps the handle and further extends his upper limb to elongate the resilient hoop while overcoming resilience provided by the resilient hoop. After a suitable number of times repeating the operation, the shoulder and the upper limb are exercised and the aching portion is massaged.

### BACKGROUND OF THE INVENTIONS

1. Field of the Invention

The present invention relates to a shoulder exerciser, and more particularly to a massaging shoulder exerciser whereby a user can simultaneously exercise and massage a shoulder.

2. Description of Related Art

In today's sedentary work style, people often experience discomfort due to sitting for hours on end in an unnatural manner. A kind of ache that is very common among office workers is a shoulder ache which occurs typically because of long term use of a computer. Many experts suggest that the best remedy to cure the shoulder ache is to exercise regularly and avoid unvaried use of the computer for a long time. However, the office workers are usually busy and have little time for exercising. Moreover, exercising equipment is rather bulky and expensive to carry around or place in an office where a user can easily access it. Another problem is that the exercising equipment currently available only exercises the user's body, but to effectively soothe the aching muscles, a massage while exercising is much preferred.

Therefore, it is an objective of the invention to provide a massaging shoulder exerciser to mitigate and/or obviate the aforementioned problems.

### SUMMARY OF THE INVENTION

An objective of the present invention is to provide a massaging shoulder exerciser that is able to exercise a user's shoulder and upper limb while massaging these portions at the same time.

Another objective of the present invention is to provide a massaging shoulder exerciser that is compact and light weight so as to be conveniently stored and even carried around.

Still another objective of the present invention is to provide a massaging shoulder exerciser that has a simple structure to be manufactured in a low cost way.

Other objectives, advantages and novel features of the invention will become more apparent from the following detailed description when taken in conjunction with the accompanying drawings.

In order to accomplish the foregoing objectives, a massaging shoulder exerciser in accordance with the present invention comprises a resilient hoop, a handle formed in a portion of the resilient hoop, and a pad formed in another portion of the resilient hoop opposed to the handle. The pad further has multiple massaging protrusions formed on an inner surface of the pad.

### BRIEF DESCRIPTION OF THE DRAWINGS

FIG. 1 is a perspective view of a massaging shoulder exerciser in accordance with the present invention;

FIG. 2 is a schematic view showing the first step in operation of the massaging shoulder exerciser;

FIG. 3 is an enlarged, schematic view showing the operation of the massaging shoulder exerciser; and

FIG. 4 is a schematic view showing the second step in the operation of the massaging shoulder exerciser.

### DETAILED DESCRIPTION OF THE PREFERRED EMBODIMENT

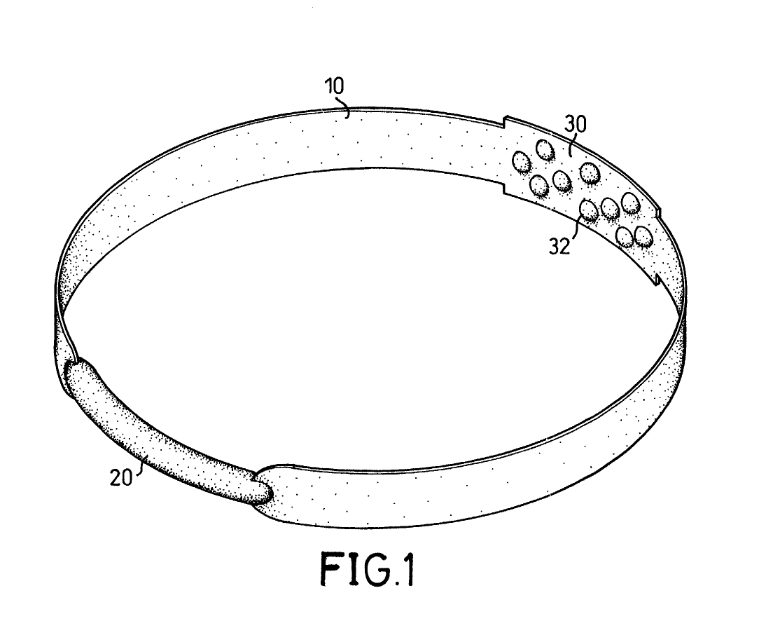

With reference to FIG. 1, a massaging shoulder exerciser in accordance with the present invention has a resilient hoop (10) made of a resilient material such as a rubber. A handle (20) and a pad (30) are respectively formed in opposed portions of the resilient hoop (10). Multiple massaging protrusions (32) are formed in an inner side of the pad (30). It should be appreciated that different formations and shapes of the massaging protrusions (32) can be adapted to provide different massaging effects.

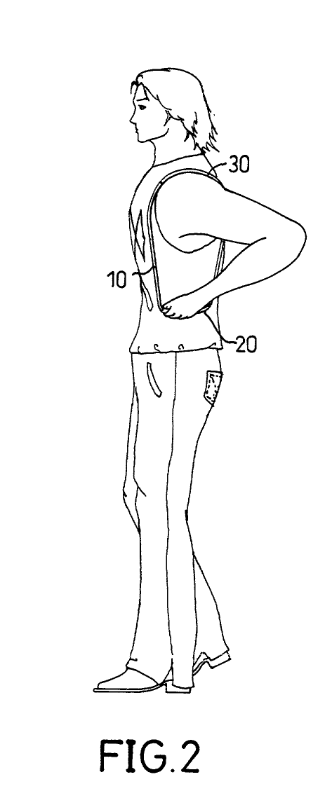

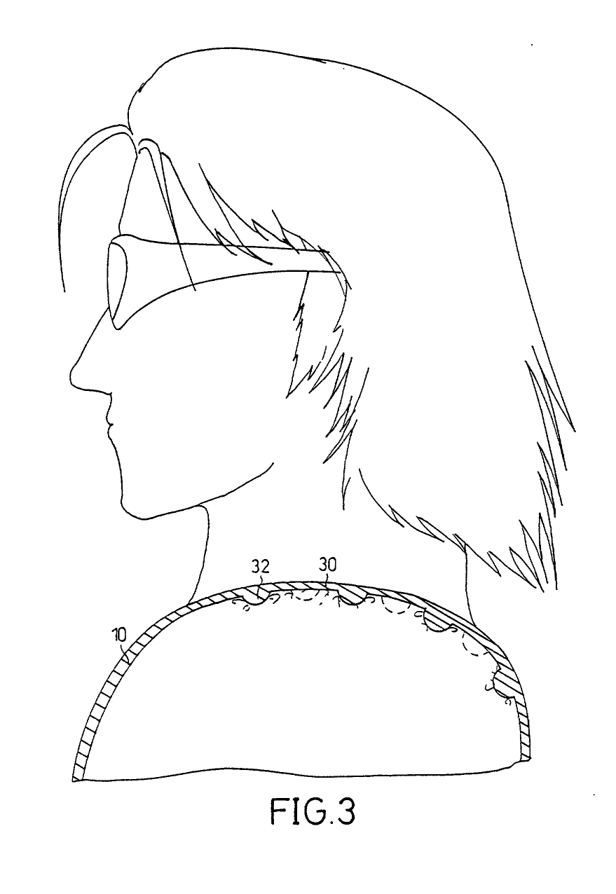

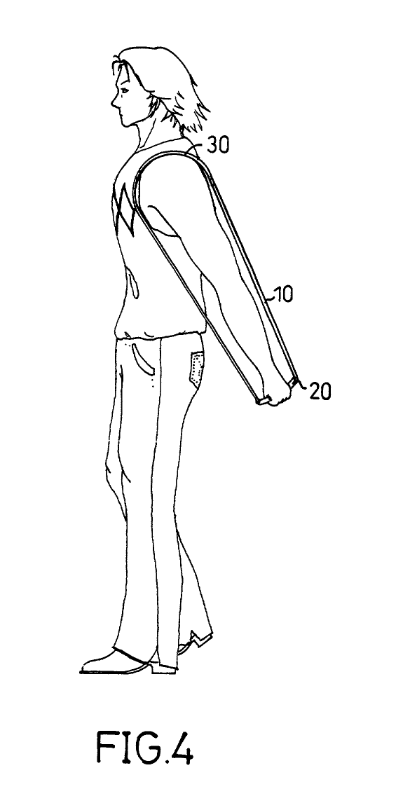

With reference to FIGS. 2 and 3, when in operation of the massaging shoulder exerciser, the first step is to extend a user's upper limb through the resilient hoop (10) to place the resilient hoop (10) around a user's shoulder, wherein the multiple massaging protrusions (32) abut an aching portion of the shoulder or near the shoulder which need to be massaged. The upper limb is further bent to allow the user to tightly grasp the handle (20). With reference to FIG. 4, the second step in the operation is to fully extend the user's upper limb to elongate the resilient hoop (10), and the user has to overcome resilience provided by the resilient hoop (10). Therefore, the upper limb and the muscles of the shoulder are exercised. However, to reach a suitable amount of exercising, the mentioned first and second steps are cyclically performed, while the massaging protrusions (32) massage the aching portion. It should be appreciated that the number of repetitions of the first and the second steps varies among different users and can be decided according to the physical capability of each user to effectively exercise the upper limb and the shoulder without injuring them.

From the above description, it is noted that the invention has the following advantages:

1. Dual Effects:

The massaging shoulder exerciser is able to exercise the user's shoulder and upper limb while massaging them. The exercising and massaging together help to effectively soothe aching muscles.

2. Light Weight and Small Size:

The massaging shoulder exerciser has a light weight and small size so as to be conveniently stored and even carried around. Therefore, the massaging shoulder exerciser can be placed almost anywhere accessible.

3. Low Cost:

The massaging shoulder exerciser can be produced in a low cost way so that everyone can purchase one without experiencing a heavy financial burden.

While this invention has been particularly shown and described with references to the preferred embodiment thereof, it will be understood by those skilled in the art that various changes in form and details may be made therein without departing from the scope of the invention encompassed by the appended claims.

What is claimed is:

1. A massaging shoulder exerciser comprising:
a resilient hoop;
a handle formed in the resilient hoop; and
a pad formed on an inner face of the resilient hoop and opposite to a position where the handle is located; and the pad having multiple massaging protrusions formed on an inner surface of the pad.

2. The massaging shoulder exerciser as claimed in claim 1, wherein the resilient hoop is made of rubber.
